(19) United States
(12) Patent Application Publication
(10) Pub. No.: US 2025/0036860 A1
(43) Pub. Date: Jan. 30, 2025

(54) INFORMATION PROCESSING DEVICE, INFORMATION PROCESSING SYSTEM, INFORMATION PROCESSING METHOD, AND RECORDING MEDIUM

(71) Applicant: NEC Corporation, Minato-ku, Tokyo (JP)

(72) Inventors: Shuji KOMEIJI, Tokyo (JP); Akira GOTOH, Tokyo (JP); Yuko NAKANISHI, Tokyo (JP); Daichi NISHII, Tokyo (JP)

(73) Assignee: NEC Corporation, Minato-ku, Tokyo (JP)

(21) Appl. No.: 18/714,127

(22) PCT Filed: Dec. 7, 2022
(86) PCT No.: PCT/JP2022/045191

§ 371 Date: May 29, 2024

(30) Foreign Application Priority Data
Dec. 16, 2021 (JP) 2021-204071

(51) Int. Cl. G06F 40/166; G06F 40/103; G06F 40/40; H04M 3/51

(52) U.S. Cl. CPC G06F 40/166; G06F 40/103; H04M 3/5116; G06F 40/40

(57) ABSTRACT

The present invention assists an operator in accurately understanding the situation at a scene, even while talking to a caller. A conversion unit converts inputted speech data into text data, an extraction unit extracts words contained in the text data from the text data, a classification unit classifies the text data into one of multiple types on the basis of the words extracted from the text data, and a display unit stores and displays information contained in the text data in a form for each type according to the type of the text data.

### TECHNICAL FIELD

The present invention relates to an information processing device, an information processing method, and a program, and for example, to an information processing device, an information processing method, and a program for supporting an operator of an emergency call center to make an input to a command terminal.

### BACKGROUND ART

In an emergency call center (command center), an operator (paramedic) inputs the contents of a case (including an incident and an accident) to a command terminal by using a keyboard or a pen device while listening to an informer. A related technology for supporting input to the command terminal has been proposed.

The emergency dispatch support system described in PTL 1 converts voice data uttered by an informer or an operator into a text by voice recognition in a voice recognition server, displays the text data on a terminal of the emergency call center, and records the text data as emergency dispatch information.

The system described in PTL 2 confirms whether text data obtained by voice recognition is correct or incorrect, and receives editing of the text data when there is an error in the text data. In addition, the system described in PTL 2 receives operator's selection of either O (correct) or X (error) with respect to text data that is a target of correct/incorrect determination.

### CITATION LIST

### Patent Literature

PTL 1: JP 2021-093228 A
PTL 2: JP 2015-184504 A

### SUMMARY OF INVENTION

### Technical Problem

In the related art described in PTL 2, text data converted from voice data is displayed on a display device in the order of time when the voice data is input. However, even while talking with an informer, it is difficult for the operator to accurately organize the obtained information by thinking and to immediately and accurately understand the situation of the scene.

The present invention has been made in view of the above problems, and an object thereof is to support an operator to accurately understand a situation of a scene even while talking with an informer.

### Solution to Problem

According to an aspect of the present invention, there is provided an information processing device including conversion means for converting input voice data into text data, extraction means for extracting a word included in the text data from the text data, sorting means for sorting the text data into any of a plurality of types based on the word extracted from the text data, and display means for storing and displaying information included in the text data in a form for each type in correspondence with a type of the text data.

According to another aspect of the present invention, there is provided an information processing method including converting input voice data into text data, extracting a word included in the text data from the text data, sorting the text data into any of a plurality of types based on the word extracted from the text data, and storing and displaying information included in the text data in a form for each type in correspondence with a type of the text data.

According to still another aspect of the present invention, there is provided a recording medium storing a program for causing a computer to execute converting input voice data into text data, extracting a word included in the text data from the text data, sorting the text data into any of a plurality of types based on the word extracted from the text data, and storing and displaying information included in the text data in a form for each type in correspondence with a type of the text data.

### Advantageous Effects of Invention

According to the aspects of the present invention, it is possible to support an operator to accurately understand a situation of a scene even while talking with an informer.

### BRIEF DESCRIPTION OF DRAWINGS

FIG. 1 is a view schematically illustrating an example of a configuration of an emergency call center including an information processing device according to example embodiments 1 and 2 and a display device on which an information processing result by the information processing device is displayed.

FIG. 2 is a view illustrating an example of an image displayed on the display device by the information processing device according to the example embodiments 1 and 2.

FIG. 3 is a block diagram illustrating a configuration of the information processing device according to the example embodiment 1.

FIG. 4 is a flowchart illustrating an operation of the information processing device according to the example embodiment 1.

FIG. 5 is a block diagram illustrating a configuration of the information processing device according to the example embodiment 2.

FIG. 6 is a view illustrating an example of an operation for pointing out an error of text data received by the information processing device according to the example embodiment 2.

FIG. 7 is a flowchart illustrating an operation of the information processing device according to the example embodiment 2.

FIG. 8 is a view illustrating an example of an operation for correcting displayed text data received by an information processing device according to a modification of the example embodiment 2.

FIG. 9 is a view illustrating an example of a hardware configuration of any of the information processing device according to the example embodiments 1 and 2.

### EXAMPLE EMBODIMENT

Example embodiments of the present invention will be described below with reference to the drawings.

### Emergency Call Center

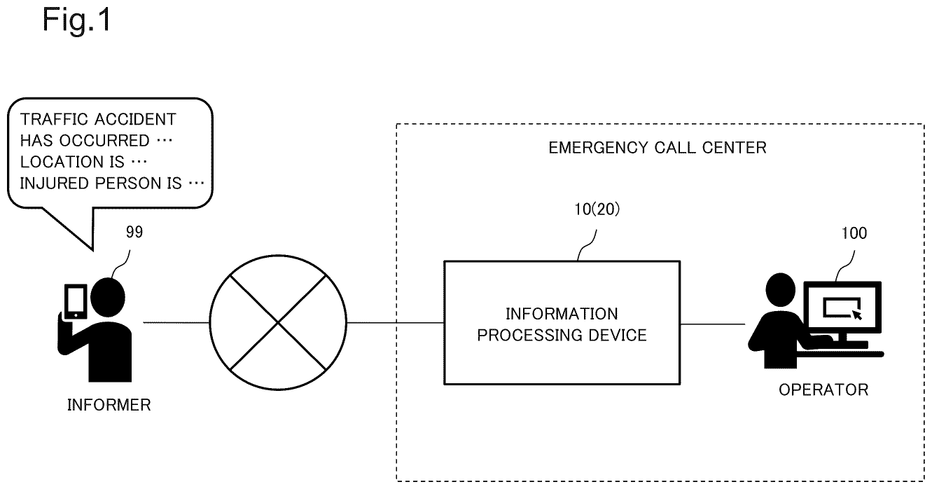

FIG. 1 illustrates an example of a configuration of an emergency call center including an information processing device 10 (20) and a display device 100 according to example embodiments 1 and 2 to be described later. Here, the “information processing device 10 (20)” represents the information processing device 10 or the information processing device 20. An information processing result by the information processing device 10 (20) is displayed on the display device 100.

As illustrated in FIG. 1, an ordinary person (hereinafter, referred to as an informer) who has encountered a case (accident or incident) calls an emergency call center. An operator of the emergency call center (for example, a paramedic) listens to the situation of the scene related to the case from the informer in order to confirm the content of the case.

For example, the informer explains to the operator whether the case is an accident or an incident, what type of case is, when and where the case occurred, the presence or absence of an injured person, the state of the injured person, and the like.

The operator inputs the information explained by the informer to a command terminal of the emergency call center. The command terminal is, for example, a personal computer. In one example, the operator can input the content of the case by voice to the command terminal by using a microphone connected to the command terminal. The voice data input to the command terminal is input to a voice recognition engine (not illustrated) and converted into text data by the voice recognition engine.

Voice data converted from the voice of the informer is input from a call terminal 99 used by the informer to the information processing device (20) according to example embodiments 1 and 2 to be described later via a telephone line or an Internet protocol (IP) line.

The information processing device 10 (20) converts the input voice data into text data. Then, the information processing device 10 (20) generates image data by analyzing the text data and sorting information obtained from the text data. The information processing device 10 (20) displays an image on the display device 100 based on the generated image data.

The display device 100 is, for example, a monitor of the command terminal used by an operator. Details of the operation of the information processing device 10 (20) will be described in example embodiments 1 and 2 to be described later.

### Example of Image Displayed on Display Device 100

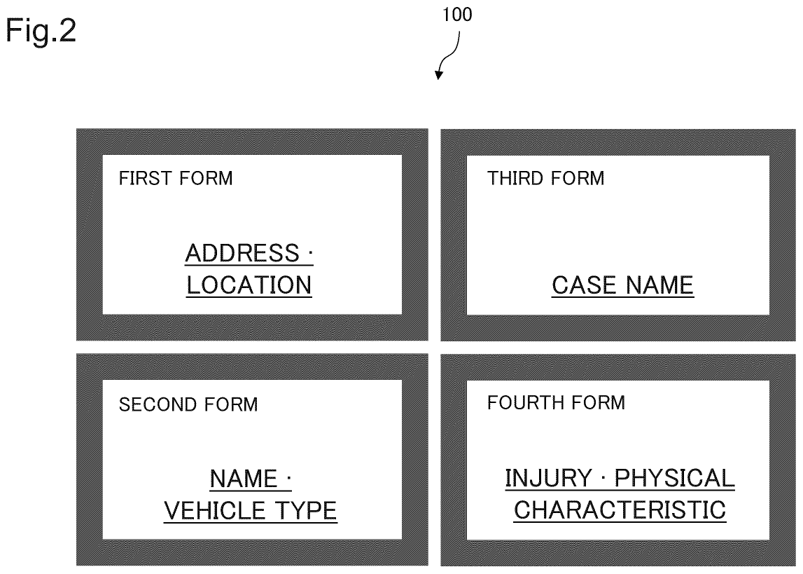

FIG. 2 illustrates an example of an image displayed on the display device 100 by the information processing device 10 (20). In the image illustrated in FIG. 2, words are sorted into one of a first form to a fourth form and are displayed in correspondence with the type of the words included in the text data. The words included in the text data are extracted from the text data by morphological analysis or the like of a text mining technology as described in example embodiments 1 and 2 described later.

In the example illustrated in FIG. 2, the words included in the text data are sorted into four types of “address/location”, “case name”, “name/vehicle type”, and “injury/physical characteristic”.

For example, the type of “address/location” includes information indicating where the case has occurred (for example, an address, a street name, an intersection name, a building serving as a mark, longitude and latitude, and global navigation satellite system (GNSS) position information). The “case name” includes information (for example, traffic accidents, quarrels, assaults, robberies, appearance of wild animals) indicating the type of the case.

For example, the “name and vehicle type” includes information indicating a name of a person related to the case, a vehicle type name of an automobile used by a person related to the case, a color and a shape of the automobile, and a car number. The “injury/physical characteristic” includes information indicating the presence or absence of an injured person, the state of the injured person, and the physical part of the injury.

### Example Embodiment 1

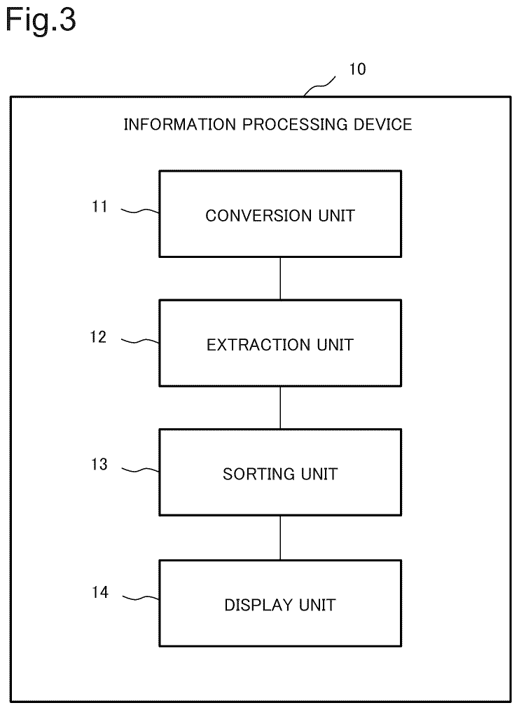

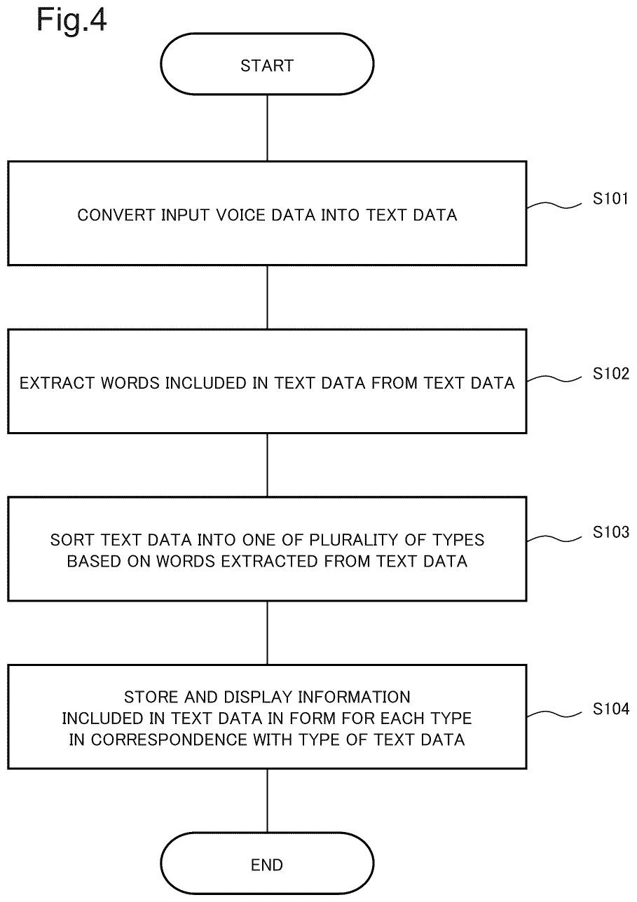

Example embodiment I will be described with reference to FIG. 3 and FIG. 4.

### Information Processing Device 10

FIG. 3 is a block diagram illustrating a configuration of the information processing device 10 according to the present example embodiment 1. As illustrated in FIG. 3, the information processing device 10 includes a conversion unit 11, an extraction unit 12, a sorting unit 13, and a display unit 14.

The conversion unit 11 converts the input voice data into text data. The conversion unit 11 is an example of conversion means.

In one example, the conversion unit 11 acquires voice data input to the information processing device 10 from the call terminal 99 (FIG. 1) of the informer through a telephone line or an IP line. The voice data is generated from the voice of the informer (that is, the other party of the call of the operator) by the call terminal 99.

The conversion unit 11 converts the input voice data into text data by using a voice recognition engine (not illustrated). The voice recognition engine includes, for example, a long short-term memory (LSTM) that is a recurrent neural network technology or a Bi-LSTM that is a bidirectional deep learning technology.

The conversion unit 11 outputs text data converted from the input voice data to the extraction unit 12.

The extraction unit 12 extracts words included in the text data from the text data. The extraction unit 12 is an example of extraction means.

In one example, the extraction unit 12 receives text data converted from the input voice data from the conversion unit 11. The extraction unit 12 divides the text data into words such as nouns, verbs, adverbs, and adjectives by morphological analysis or the like of the text mining technology. The extraction unit 12 may use a well-known natural language analysis technology different from the text mining technology.

Thereafter, the extraction unit 12 extracts a word and a dependency expression (adjectives, adverbs, and the like) closely related to a keyword for each type from the text data. Here, “closely related” means that the frequency of appearance with the keyword for each type is high, and that a time distance to the keyword of the type is close in the text data.

For example, in a sentence “Traffic accident has occurred on YY-chome, XX city.”, “city” and “chome” are keywords of the type, and “XX city” and “YY chome” are words related to the type.

The extraction unit 12 outputs word data extracted from the text data such as words closely related to keywords of the type and a dependency expression thereof to the sorting unit 13 in combination with the text data. The number of keywords of the type is not limited to one for each type, and may be plural.

The extraction unit 12 may discriminate text data including information related to the case and text data not including information related to the case from each other. The information related to the case is, for example, a type of the case (traffic accident, assault, or the like), a location where the case has occurred, a name of a person related to the case, presence or absence of an injured person, or a state of the injured person. The information related to the case may relate to keywords for each type.

In a case where the text data includes one or more words closely related to any type of keywords, the extraction unit 12 determines that the text data includes information related to the case. In this case, the extraction unit 12 outputs the word data extracted from the text data to the sorting unit 13.

On the other hand, when the text data does not include any word closely related to any type of keywords, the extraction unit 12 determines that the text data does not include information related to the case. In this case, the extraction unit 12 determines that the word data extracted from the text data is not to be output to the sorting unit 13. The sorting unit 13 sorts the text data into one of a plurality of types based on words extracted from the text data. The sorting unit 13 is an example of sorting means.

In one example, the sorting unit 13 receives word data extracted from the text data from the extraction unit 12. The sorting unit 13 sorts the text data based on a relationship between the keywords for each type and the words extracted from the text data.

For example, it is assumed that the words “XX city” and “YY chome” included in the text data are closely related to the keywords “city” and “chome” of the type of “address/location” (FIG. 2). In this case, the sorting unit 13 sorts the text data into a type of “address/location”.

The sorting unit 13 outputs the sorting result of the text data to the display unit 14 in combination with the text data. The sorting result of the text data includes information indicating a type to which the text data belongs.

The display unit 14 stores and displays information included in the text data in a form for each type in correspondence with the type of text data. The display unit 14 is an example of display means.

In one example, the display unit 14 receives the sorting result of the text data from the sorting unit 13. The display unit 14 specifies the sorting of the text data from the sorting result of the text data. The display unit 14 stores the information included in the text data in a form of the specified type.

Then, the display unit 14 generates image data of a form storing information included in the text data. The display unit 14 transmits the generated image data to the display device 100, and displays an image based on the image data on a screen of the display device 100.

Alternatively, the display unit 14 may also display a character string based on the text data on the display device 100. As a result, the operator (FIG. 1) can easily find erroneous conversion of the voice data by reading out the displayed character string.

### Operation of Information Processing Device 10

The operation of the information processing device 10 according to the present example embodiment 1 will be described with reference to FIG. 4. FIG. 4 is a flowchart illustrating a flow of processing executed by each unit of the information processing device 10.

First, voice data is input from the call terminal 99 (FIG. 1) used by the informer to the information processing device 10 via a telephone line or an IP line. Thereafter, each unit of the information processing device 10 executes processing described below.

As illustrated in FIG. 4, the conversion unit 11 converts the input voice data into text data (S101).

The conversion unit 11 outputs text data converted from the input voice data to the extraction unit 12.

The extraction unit 12 receives the text data converted from the input voice data from the conversion unit 11. The extraction unit 12 extracts words included in the text data from the text data (S102).

The extraction unit 12 outputs the word data extracted from the text data to the sorting unit 13 in combination with the text data.

The sorting unit 13 receives word data extracted from the text data from the extraction unit 12. The sorting unit 13 sorts the text data into one of a plurality of types based on words extracted from the text data (S103).

The sorting unit 13 outputs the sorting result of the text data to the display unit 14 in combination with the text data. The sorting result of the text data includes information indicating a type of the text data.

The display unit 14 receives the sorting result of the text data from the sorting unit 13. The display unit 14 stores and displays information included in the text data in a form for each type in correspondence with the type of text data (S104).

As described above, the operation of the information processing device 10 according to the present example embodiment 1 is terminated.

### Effects of Present Example Embodiment

According to the configuration of the present example embodiment, the conversion unit 11 converts the input voice data into the text data. The extraction unit 12 extracts words included in the text data from the text data. The sorting unit 13 sorts the text data into one of a plurality of types based on words extracted from the text data. The display unit 14 stores and displays information included in the text data in a form for each type in correspondence with the type of text data.

As described above, since the information included in the text data is organized and displayed for each type, the operator can easily understand a situation of the scene from the displayed information. Therefore, the operator can accurately understand the situation of the scene even while talking with the informer.

### Example Embodiment 2

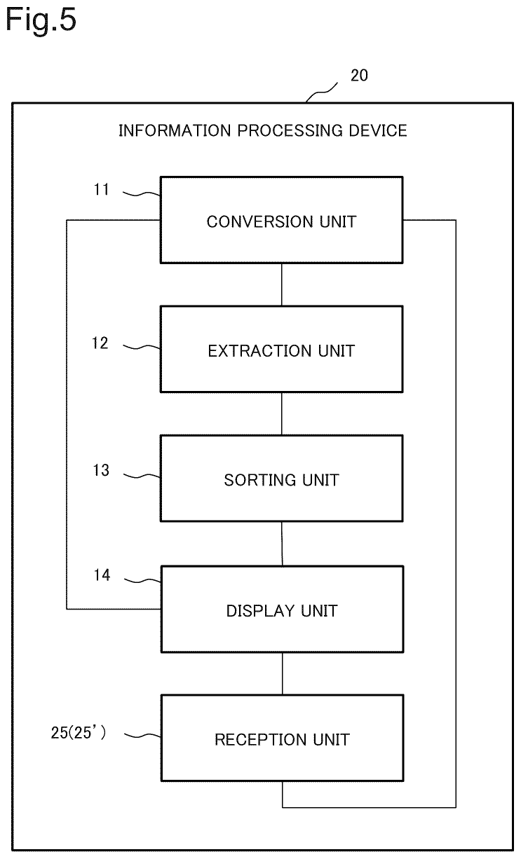

Example embodiment 2 will be described with reference to FIG. 5 to FIG. 8. In the present example embodiment 2, description will be given of a configuration that enables an operator (user) to point out an error in information displayed on the display device 100 or an error in text data converted from voice data, and the operator (user) to correct the error.

### Information Processing Device 20

FIG. 5 is a block diagram illustrating a configuration of the information processing device 20 according to the present example embodiment 2. As illustrated in FIG. 5, the information processing device 20 includes the conversion unit 11, the extraction unit 12, the sorting unit 13, and the display unit 14. The information processing device 20 further includes a reception unit 25.

The reception unit 25 receives an operation for pointing out an error of information or an error of text data displayed on the display device 100 (FIG. 1) or the like. The reception unit 25 is an example of reception means.

In one example, the reception unit 25 acquires information included in the text data from the display unit 14 in combination with the text data. The reception unit 25 confirms whether the information included in the text data and the text data itself are correct with respect to the operator (user).

For example, if there is an error in the information displayed on the display device 100 (FIG. 2), the reception unit 25 makes a request for the operator (user) to point out the error by a predetermined operation. In order to receive the operation for pointing out an error of the text data, the reception unit 25 may make an instruction for the display unit 14 to display an image exemplified below.

### Example of Operation for Pointing Out Error of Text Data

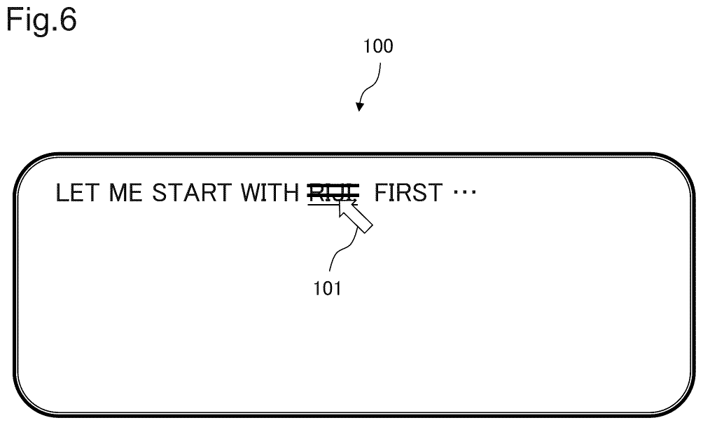

An example of an image displayed on the display unit 14 by the reception unit 25 will be described with reference to FIG. 6. FIG. 6 illustrates an example of an operation for pointing out an error in the text data.

In FIG. 6, a character string is displayed on a screen of the display device 100. The character string is “let me start with RIJI. First . . . ”. The character string displayed on the screen of the display device 100 is generated from the text data converted from the voice data.

It is assumed that the operator (user) notices that the character string “RIJI” is an error of “GIJI”. In this case, the operator (user) performs an input operation on the command terminal by using an input device such as touch input pen 101.

As illustrated in FIG. 6, the operator (user) performs an operation for pointing out that the character string “RIJI” is incorrect by using the touch input pen 101 or the like on the character string of “RIJI” on the screen of the display device 100.

The reception unit 25 acquires information regarding the input operation performed on the command terminal. Then, the reception unit 25 detects that the operation for pointing out that the character string “RIJI” is incorrect has been input based on the information regarding the input operation.

The reception unit 25 may notify the conversion unit 11 that the operation for pointing out the error of the text data has been input, and output information for specifying the character string “RIJI” pointed out to the conversion unit 11.

The conversion unit 11 receives a notification from the reception unit 25 that the operation for pointing out the error in the text data has been input. The conversion unit 11 corrects the text data in which the error is pointed out. Specifically, the conversion unit 11 corrects text data of a first conversion candidate in which the error is pointed out to text data of a second conversion candidate different from the first conversion candidate.

Alternatively, instead of the text data itself, the reception unit 25 may receive an operation for pointing out an error of information included in the text data. As illustrated in FIG. 2, the information is stored and displayed in a type form (In FIG. 2, a first form to a fourth form are illustrated).

For example, the operator (user) performs an operation for pointing out an error in the information (FIG. 2) displayed on the display device 100. Similarly to the procedure described above, the reception unit 25 receives the operation for pointing out the error in the displayed information.

The configuration in which the reception unit 25 receives the operation for pointing out the error of the displayed information or text data has been described above. In addition, the configuration in which conversion unit 11 automatically corrects the text data in which the error is pointed out has been described. However, the method of correcting the text data is not limited thereto.

Alternatively, the reception unit 25 may further receive an operation for correcting the displayed information or text data from the operator (user). In one example, the reception unit 25 receives correction of information or text data in which an error is pointed out by text input (a modification example of example embodiment 2).

### Operation of Information Processing Device 20

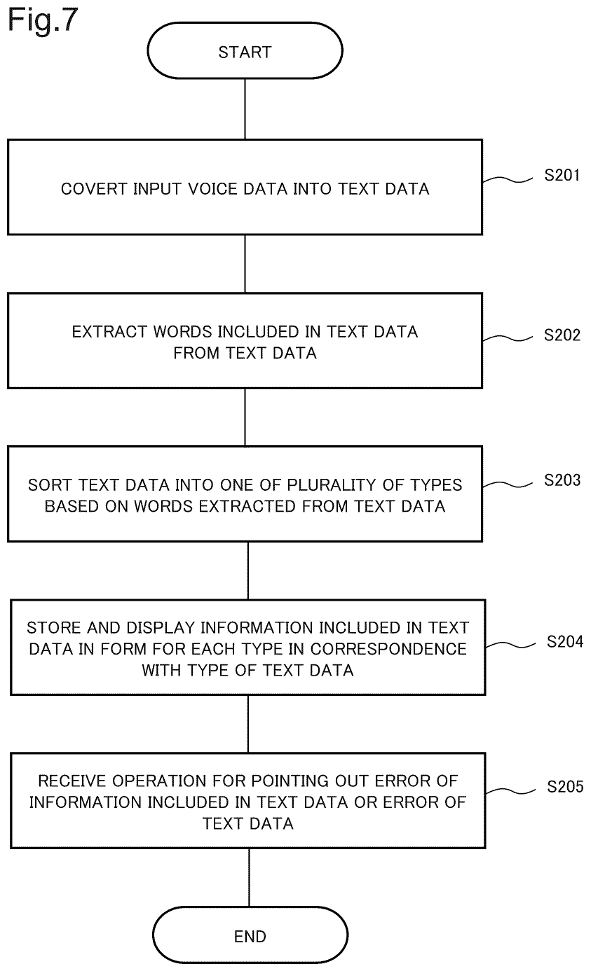

An operation of the information processing device 20 according to the present example embodiment 2 will be described with reference to FIG. 7. FIG. 7 is a flowchart illustrating a flow of processing executed by each unit of the information processing device 20.

First, voice data is input from the call terminal 99 (FIG. 7) used by the informer to the information processing device 20 via a telephone line or an IP line. Thereafter, each unit of the information processing device 20 sequentially executes processing described below.

As illustrated in FIG. 7, the conversion unit 11 converts the input voice data into text data (S201).

The conversion unit 11 outputs text data converted from the input voice data to the extraction unit 12.

The extraction unit 12 receives the text data converted from the voice data from the conversion unit 11. The extraction unit 12 extracts words included in the text data from the text data (S202).

The extraction unit 12 outputs the word data extracted from the text data to the sorting unit 13 in combination with the text data.

The sorting unit 13 receives word data extracted from the text data from the extraction unit 12. The sorting unit 13 sorts the text data into one of a plurality of types based on words extracted from the text data (S203).

The sorting unit 13 outputs the sorting result of the text data to the display unit 14 in combination with the text data. The sorting result of the text data includes information indicating a type of the text data.

The display unit 14 receives the sorting result of the text data from the sorting unit 13. The display unit 14 stores and displays information included in the text data in a form for each type in correspondence with the type of text data (S204).

The display unit 14 outputs information included in the text data to the reception unit 25 in combination with the text data.

The reception unit 25 receives information included in the text data from the display unit 14 in combination with the text data. The reception unit 25 receives an operation for pointing out an error of information or an error of text data displayed on the display device 100 (FIG. 1) or the like (S205).

Thereafter, the reception unit 25 may notify the conversion unit 11 that the operation for pointing out the error in the text data has been input. In this case, the conversion unit 11 corrects the text data with reference to conversion candidates of the voice data.

As described above, the operation of the information processing device 20 according to the present example embodiment 2 is terminated.

### Modification Examples

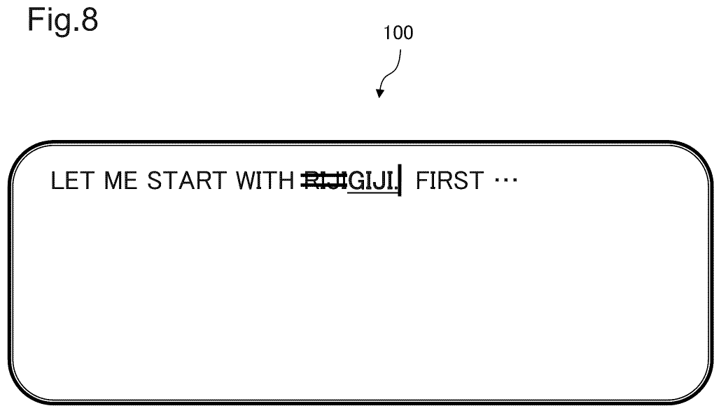

A modification example of the present example embodiment 2 will be described with reference to FIG. 8.

The configuration in which the reception unit 25 receives the operation (FIG. 6) for pointing out the error of the text data has been described above.

The reception unit 25′ (FIG. 5) according to the modification example further receives an operation for correcting the displayed information or text data.

For example, the reception unit 25′ receives correction of text data in which an error is pointed out by text input.

In FIG. 8, a character string is displayed on a screen of the display device 100. The character string is “let me start with RIJI. First . . . ”. The character string displayed on the screen of the display device 100 corresponds to the text data converted from the voice data.

It is assumed that the operator (user) notices that the character string “RIJI” is an error of “GIJI”. In this case, the operator (user) performs an input operation on the command terminal by using an input device such as touch input pen 101.

For example, the operator (user) performs an operation for pointing out an error by using the touch input pen 101 on the character string of “RIJI” on the screen of the display device 100. Thereafter, the operator (user) performs text input by using an input device (not illustrated) such as a keyboard.

As illustrated in FIG. 8, the operator (user) inputs “GIJI”, which is a correct character string, to the command terminal. The reception unit 25′ acquires information regarding an input operation to the command terminal. Then, the reception unit 25′ detects that the operation for correcting the error in the text data has been input.

The reception unit 25′ notifies the conversion unit 11 that the operation for correcting the error of the text data has been input. At the same time, the reception unit 25′ outputs information specifying data corresponding to the character code of “GIJI” to the conversion unit 11.

The conversion unit 11 receives a notification from the reception unit 25′ that the operation for correcting the error in the text data has been input. The conversion unit 11 corrects the text data according to the correction made by the operator (user). Specifically, the conversion unit 11 corrects a character code corresponding to the character string “RIJI” to a character code corresponding to “GIJI” in the text data converted from the voice data.

The conversion unit 11 outputs the corrected text data to the display unit 14. The display unit 14 causes the display device 100 to display a character string based on the corrected text data.

As illustrated in FIG. 8, the text data after correction and the corresponding character string “let me start with GIJI. First, . . . ” is displayed on display device 100. As compared with the character string illustrated in FIG. 6, the character string “RIJI” in FIG. 6 is replaced with the character string “GIJI” in FIG. 8.

According to the configuration of the present modification example, the operator (user) can not only point out errors in the displayed information or text data, but also can easily correct the information or text data by its own operation.

### Effects of Present Example Embodiment

According to the configuration of the present example embodiment, the conversion unit 11 converts the input voice data into the text data. The extraction unit 12 extracts words included in the text data from the text data. The sorting unit 13 sorts the text data into one of a plurality of types based on words extracted from the text data. The display unit 14 stores and displays information included in the text data in a form for each type in correspondence with the type of text data.

As described above, since the information included in the text data is organized and displayed for each type, the operator can easily understand a situation of the scene from the displayed information.

Therefore, the operator can accurately understand the situation of the scene even while talking with the informer.

Furthermore, according to the configuration of the present example embodiment, the reception unit 25 receives the operation for pointing out an error in the displayed information or an error in the text data.

As a result, when there is an error in the conversion of the voice data, the error can be found based on the pointing-out. Furthermore, the reception unit 25′ can reliably correct the error by receiving the operation for correcting the error.

### Hardware Configuration

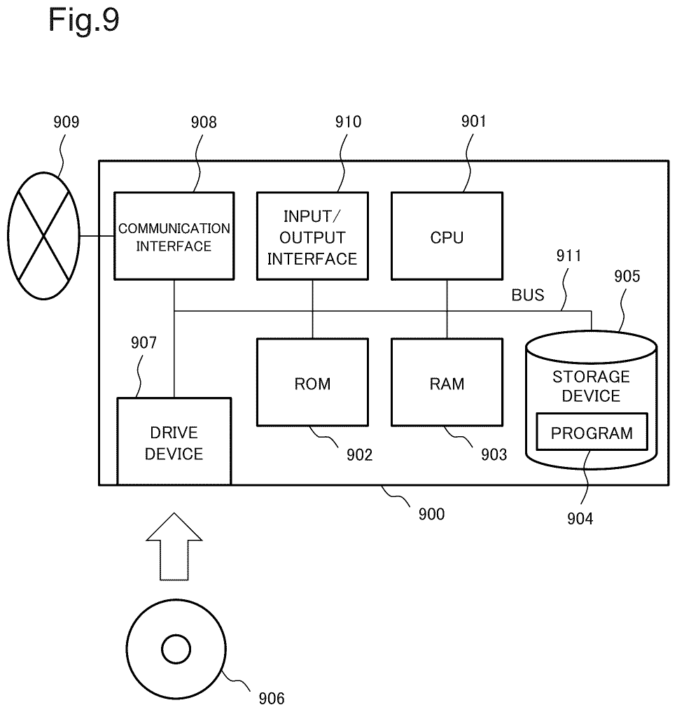

Each component of the information processing devices 10 and 20 described in the example embodiments 1 and 2 indicates a block of a functional unit. Some or all of these components are implemented by an information processing device 900 as illustrated in FIG. 9, for example. FIG. 9 is a block diagram illustrating an example of a hardware configuration of the information processing device 900.

As illustrated in FIG. 9, the information processing device 900 includes the following configuration as an example.
Central processing unit (CPU) 901
Read only memory (ROM) 902
Random access memory (RAM) 903
Program 904 loaded to RAM 903
Storage device 905 storing program 904
Drive device 907 for performing reading and writing of recording medium 906
Communication interface 908 connected to communication network 909
Input/output interface that performs input and output of data 910
Bus connecting each of components 911

Each of components of the information processing devices 10 and 20 described in the example embodiments 1 and 2 are implemented when the CPU 901 reads and executes the program 904 that implements these functions. For example, the program 904 for implementing the function of each of the components is stored in the storage device 905 or the ROM 902 in advance, and the CPU 901 loads the program into the RAM 903 and executes the program as necessary. The program 904 may be supplied to the CPU 901 via the communication network 909, or may be stored in advance in the recording medium 906, and the drive device 907 may read the program and supply the program to the CPU 901.

According to the above configuration, the information processing devices 10 and 20 described in the example embodiments 1 and 2 are implemented as hardware. Therefore, an effect similar to the effect described in any one of the example embodiments 1 and 2 can be obtained.

### Supplementary Note

One aspect of the present invention is also described as the following supplementary notes, but is not limited to the following description.

### Supplementary Note 1

An information processing device including:

conversion means for converting input voice data into text data;

extraction means for extracting a word included in the text data from the text data;

sorting means for sorting the text data into any of a plurality of types based on the word extracted from the text data; and

display means for storing and displaying information included in the text data in a form for each type in correspondence with a type of the text data.

### Supplementary Note 2

The information processing device according to Supplementary Note 1, further including

reception means for receiving an operation for pointing out an error of the displayed information or an error of the text data.

### Supplementary Note 3

The information processing device according to Supplementary Note 2, wherein

the reception means further receives an operation for correcting the displayed information or the text data.

### Supplementary Note 4

The information processing device according to Supplementary Note 3, wherein

the reception means receives correction of the text data in which an error has been pointed out by text input.

### Supplementary Note 5

An information processing method including:

converting input voice data into text data;

extracting a word included in the text data from the text data;

sorting the text data into any of a plurality of types based on the word extracted from the text data; and

storing and displaying information included in the text data in a form for each type in correspondence with a type of the text data.

### Supplementary Note 6

The information processing method according to Supplementary Note 5, further including

receiving an operation for pointing out an error of the displayed information or an error of the text data.

### Supplementary Note 7

The information processing method according to Supplementary Note 6, including

further receiving an operation for correcting the displayed information or the text data.

### Supplementary Note 8

The information processing method according to Supplementary Note 7, further including

receiving correction of the text data in which an error has been pointed out by text input.

### Supplementary Note 9

A program for causing a computer to execute:

converting input voice data into text data;

extracting a word included in the text data from the text data;

sorting the text data into any of a plurality of types based on the word extracted from the text data; and

storing and displaying information included in the text data in a form for each type in correspondence with a type of the text data.

### Supplementary Note 10

The program according to Supplementary Note 9, further causing the computer to execute

receiving an operation for pointing out an error in the displayed information or an error in the text data.

### Supplementary Note 11

The program according to Supplementary Note 10, causing the computer to execute

further receiving an operation for correcting the displayed information or the text data.

### Supplementary Note 12

The program according to Supplementary Note 11, causing the computer to execute

receiving correction of the text data in which an error has been pointed out.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2021-204071, filed on Dec. 16, 2021, the disclosure of which is incorporated herein in its entirety by reference.

### INDUSTRIAL APPLICABILITY

The present invention can be used, for example, to assist an operator of an emergency call center to understand a situation of a scene and to input contents of a case to a command terminal.

### REFERENCE SIGNS LIST

10 information processing device
11 conversion unit
12 extraction unit
13 sorting unit
14 display unit
20 information processing device
25 reception unit
25′ reception unit
100 display device

What is claimed is:

1. An information processing device comprising:
a memory configured to store instructions; and
at least one processor configured to execute the instructions to perform:
converting input voice data into text data;
extracting a word included in the text data from the text data;
sorting the text data into any of a plurality of types based on the word extracted from the text data; and
for storing and displaying information included in the text data in a form for each type in correspondence with a type of the text data.

2. The information processing device according to claim 1, wherein
the at least one processor is further configured to execute the instructions to perform:
receiving an operation for pointing out an error of the displayed information or an error of the text data.

3. The information processing device according to claim 2, wherein
the at least one processor is further configured to execute the instructions to perform:
receiving an operation for correcting the displayed information or the text data.

4. The information processing device according to claim 3, wherein
the at least one processor is further configured to execute the instructions to perform:
receiving correction of the text data in which an error has been pointed out by text input.

5. An information processing method comprising:
converting input voice data into text data;
extracting a word included in the text data from the text data;
sorting the text data into any of a plurality of types based on the word extracted from the text data; and
storing and displaying information included in the text data in a form for each type in correspondence with a type of the text data.

6. The information processing method according to claim 5, further comprising
receiving an operation for pointing out an error of the displayed information or an error of the text data.

7. A non-transitory recording medium storing a program for causing a computer to execute:
converting input voice data into text data;
extracting a word included in the text data from the text data;
sorting the text data into any of a plurality of types based on the word extracted from the text data; and
storing and displaying information included in the text data in a form for each type in correspondence with a type of the text data.

8. The non-transitory recording medium according to claim 7, further causing the computer to execute
receiving an operation for pointing out an error in the displayed information or an error in the text data.
